(19) United States
(12) Patent Application Publication
(10) Pub. No.: US 2013/0240459 A1
(43) Pub. Date: Sep. 19, 2013

(54) IRRIGATION DIVERTER, AND RELATED SYSTEMS AND METHODS

(71) Applicant: Frank Andrews, Dryden, WA (US)

(72) Inventor: Frank Andrews, Dryden, WA (US)

(21) Appl. No.: 13/845,479

(22) Filed: Mar. 18, 2013

Related U.S. Application Data
(60) Provisional application No. 61/612,365, filed on Mar. 18, 2012.

(51) Int. Cl. B01D 29/64

(52) U.S. Cl. CPC B01D 29/6469
USPC 210/791; 210/355

(57) ABSTRACT

An irrigation diverter for diverting a flow of liquid from a larger flow includes a housing, a filter to trap unwanted debris, a cleaner to remove the trapped debris from the filter, and a turbine to power the cleaner. The housing has an inlet and an outlet. The filter is disposed between the inlet and the outlet and operable to allow liquid entering the housing through the inlet to flow to the outlet while preventing debris in the liquid from reaching the outlet. The cleaner scrapes the filter to remove the debris trapped by the filter, and the turbine extracts energy from the larger flow of liquid to power the cleaner. By powering the cleaner with energy extracted from the flowing liquid, one does not have to frequently visit the diverter to manually remove debris from the filter. And, the filter may be continuously cleaned to prevent a buildup of debris trapped by the filter. This, in turn, allows a substantially steady flow of liquid through the diverter and toward a desired location away from the stream, river, lake and/or canal that the diverted is located in.

### CROSS REFERENCE TO RELATED APPLICATION AND CLAIM OF PRIORITY

This application claims priority from commonly owned U.S. Provisional Patent Application 61/612,365 filed 18 Mar. 2012, and titled “SELF-CLEANING, IRRIGATION DITCH SCREEN”, presently pending, which is incorporated by reference.

### BACKGROUND

Many farms, orchards and ranches receive the water necessary for irrigating crops and watering livestock from streams, rivers or lakes located nearby. If the necessary water is not located nearby then one or more canals are dug to convey the water close to where it's needed. To obtain the water from the stream, river, lake and/or canal, a diverter is typically placed in the flowing water and coupled to a pipe that conveys the water diverted by the diverter to the field of crops, trees, or animals that need it. If the pipe runs up, over the bank of the stream, river, lake or canal, then a pump may be coupled to the pipe to draw water out of the stream, river, lake or canal. If, however, the pipe runs through the bank of the stream, river, lake or canal, then a pump may not be needed to draw water out of the stream, river, lake or canal.

Because streams, rivers, lakes and canals often have debris such as leaves, branches, logs, and silt that remains suspended in the water, the diverter typically includes a filter to prevent the debris from entering the pipe and clogging or adversely affecting the flow of water through the pipe. Unfortunately, such filters get clogged from the debris, and remain clogged because the pressure of the water flowing in the canal pins the debris against the filter. Eventually, much of the filter becomes clogged with debris such that very little water, and sometimes none, passes through the filter and into the pipe for use elsewhere.

To keep water flowing through the filter of the diverter, farmers and/or ranchers frequently visit the diverter to clean the filter. During the spring when the water flowing in most streams, rivers, lakes and canals carry much debris, the farmer and/or rancher may clean a single diverter twice or three times a day. To clean a filter of the diverter, one typically has to use a brush mounted to a long handle, or get into the water and manually remove debris with one's own hands. This frequent cleaning of the diverter's filter is time-consuming and uncomfortable—especially if the stream or river caries water from mountain snows.

### SUMMARY

In one aspect of the invention, an irrigation diverter for diverting a flow of liquid from a larger flow includes a housing, a filter to trap unwanted debris, a cleaner to remove the trapped debris from the filter, and a turbine to power the cleaner. The housing has an inlet and an outlet. The filter is disposed between the inlet and the outlet and operable to allow liquid entering the housing through the inlet to flow to the outlet while preventing debris in the liquid from reaching the outlet. The cleaner scrapes the filter to remove the debris trapped by the filter, and the turbine extracts energy from the larger flow of liquid to power the cleaner. By powering the cleaner with energy extracted from the flowing liquid, one does not have to frequently visit the diverter to manually remove debris from the filter. And, the filter may be continuously cleaned to prevent a buildup of debris trapped by the filter. This, in turn, allows a substantially steady flow of liquid through the diverter and toward a desired location away from the stream, river and/or canal that the diverted is located in.

In another aspect of the invention, an irrigation diverter includes a coupler to couple the diverter to a pipe that conveys the diverted liquid to a desired location, and that allows one to position the diverter out of the flowing liquid. With the coupler, one can easily remove the diverter from the stream, river, lake and/or canal to visually inspect the diverter and/or modify the diverter by changing the turbine and/or filter to correspond with changes in the flowing liquid.

### BRIEF DESCRIPTION OF THE FIGURES

FIG. 1 is a perspective view of an irrigation diverter according to an embodiment of the invention.

FIG. 1A is a partial, perspective, sectional view of the diverter in FIG. 1.

FIG. 2 is another view of the irrigation diverter shown in FIG. 1.

FIG. 3 is an exploded, perspective view of the irrigation diverter shown in FIGS. 1 and 2.

### DETAILED DESCRIPTION

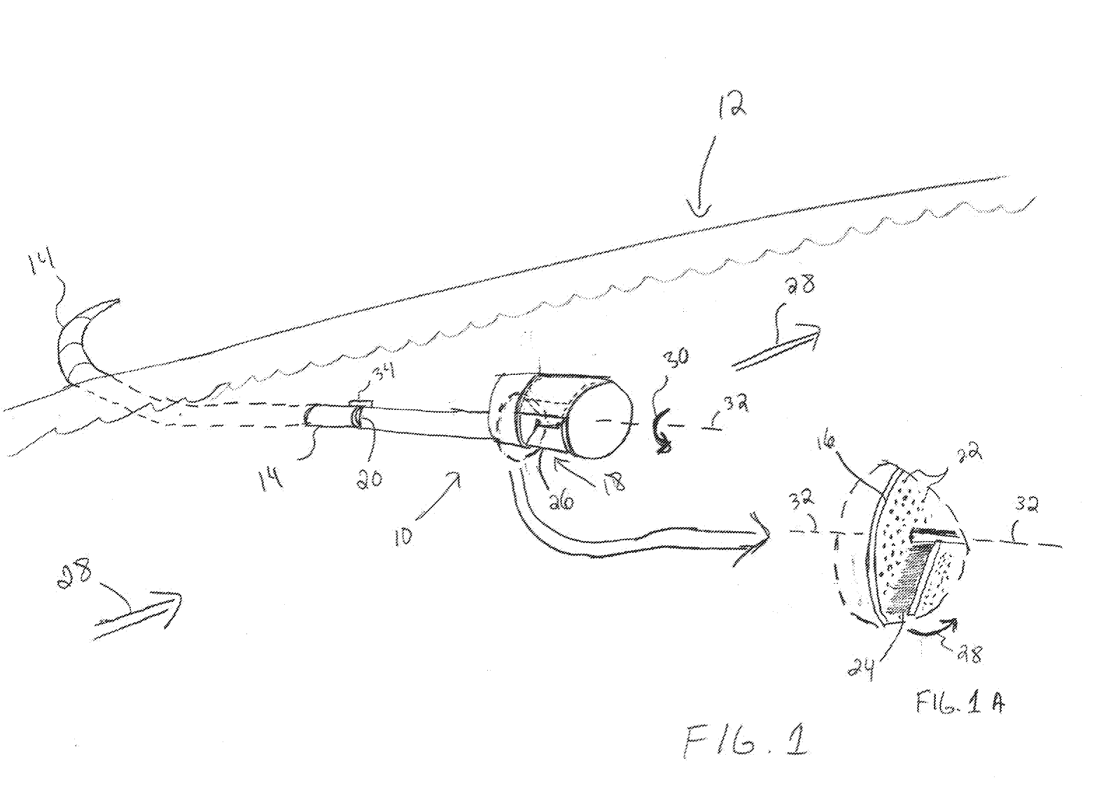

FIG. 1 is a perspective view of an irrigation diverter 10 according to an embodiment of the invention. FIG. 1A is a partial, perspective, sectional view of the diverter 10 in FIG. 1. The diverter 10 diverts liquid (here water but may be any desired liquid) flowing in a canal 12 into a pipe 14 to be conveyed to a remote location. The remote location may be an orchard of trees bearing fruit or nuts, or a field of crops such as broccoli, corn or barley, or the remote location may be a watering hole for livestock. Although shown positioned in a canal 12, the diverter 10 can be positioned in a stream, river, lake or any desired liquid-conveying structure to divert liquid from the structure. As shown in FIG. 1, the diverter 10 is submerged in the flowing water, but, the diverter 10 may be positioned at the surface of the flow to avoid diverting water flowing below the surface. Also, although the diverter 10 is shown in FIG. 1 disposed horizontally in the canal 12, the diverter 10 may be disposed in another orientation, such vertical or any angle between horizontal and vertical.

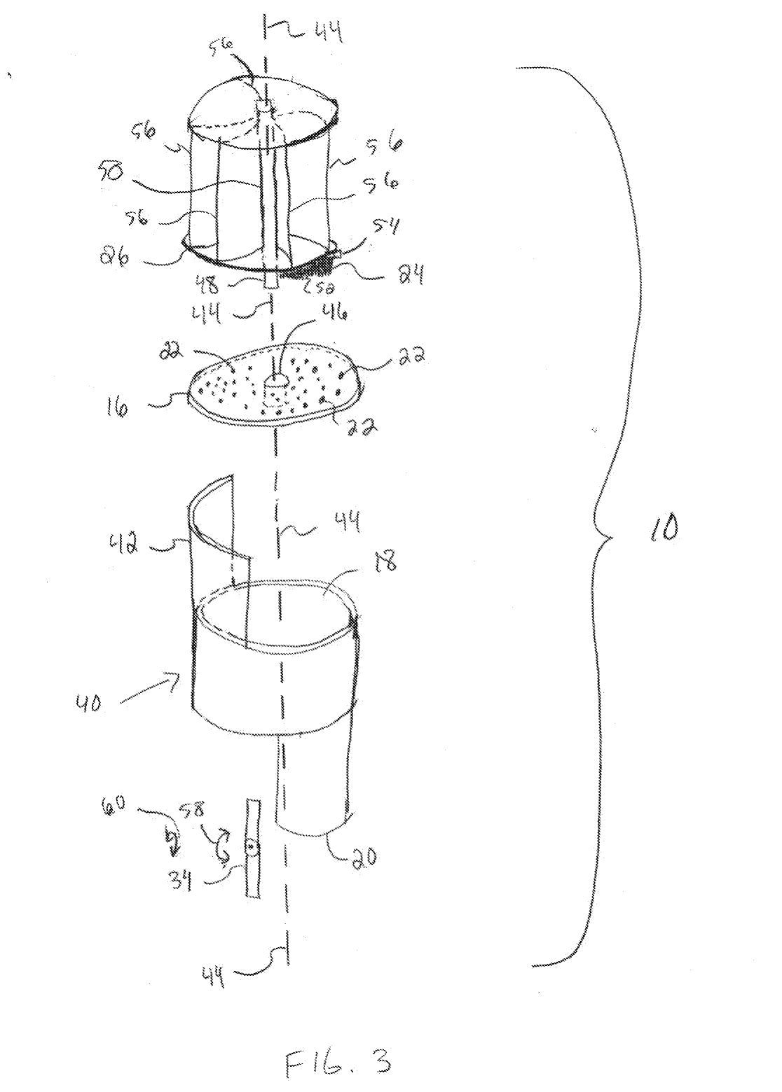

In this and other embodiments, the diverter 10 includes a filter 16 (FIG. 1A) (discussed in greater detail in conjunction with FIG. 3) to stop unwanted debris such as leaves, branches, logs, trash, and silt suspended in the flow of water from flowing into the pipe 14. The filter 16 is disposed between the inlet 18 and the outlet 20 and includes holes 22 (only two labeled in FIG. 1A for clarity) that allow water to flow to the outlet 20 while preventing debris in the water from reaching the outlet 20. The diverter also includes a cleaner 24 (FIG. 1A) (also discussed in greater detail in conjunction with FIG. 3) to scrape the filter 16 to remove the debris trapped by the filter 16. The diverter 10 also includes a turbine 26 (FIG. 1) (also discussed in greater detail in conjunction with FIG. 3) to power the cleaner 24 from energy that the turbine 26 extracts from the water flowing in the canal 12.

In operation, water flowing in the canal in the direction indicated by the arrow 28 flows past and around the diverter 10. Some of this water enters the diverter 10 through the inlet 18 and contacts the filter 16. Because the filter 16 includes holes 22, some of the water that contacts the filter 16 flows through the holes 22 toward the diverter's outlet 20, while debris larger than holes 22 is prevented from flowing toward the outlet 20. Because water flows through the filter 16, the water contacting the filter 16 exerts pressure against the filter 16 that pins or traps debris that is stopped by the filter 16. To remove the debris from the filter 16, the cleaner 24 scrapes the filter 16 and dislodges the debris from the filter 16. Once dislodged, the debris is carried downstream, away from the diverter 10, by the water flowing adjacent the filter 16. To scrape the filter 16, the cleaner 24 moves across the surface of the filter in the direction indicated by the arrow 28. The turbine 26 moves the cleaner 24 across the surface of the filter 16 by absorbing some of the energy in the flowing water. The absorbed energy causes the turbine 26 to rotate in the direction indicated by the arrow 30, which, in turn, causes the cleaner 24 to rotate about the axis 32.

By powering the cleaner with energy extracted from the water flowing in the canal 12, one does not have to frequently visit the diverter 10 to manually remove debris from the filter 16. And, the filter 16 may be continuously cleaned to prevent a build-up of debris trapped by the filter 16, which, in turn, allows a substantially steady flow of water through the pipe 14 and toward a desired location away from the canal 12.

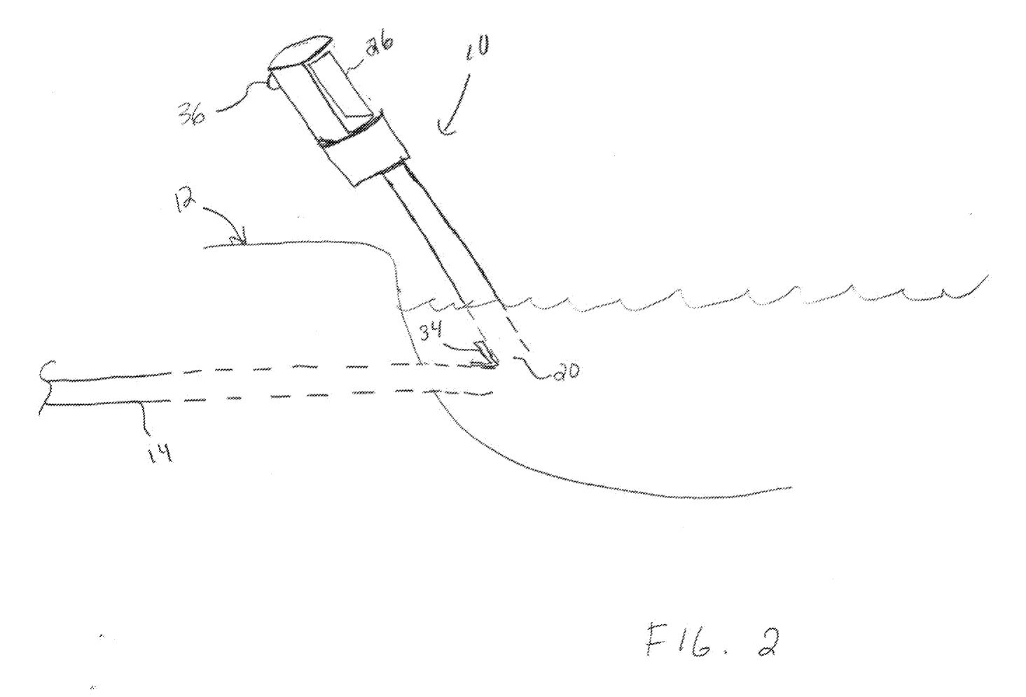

FIG. 2 is another view of the irrigation diverter 10 shown in FIG. 1. In this and other embodiments, the diverter 10 also includes a coupler 34 (also shown in FIG. 1) that couples the diverter 10 to a pipe 14 that conveys the diverted water away from the canal 12, and that allows one to position the diverter 10 out of the flowing liquid. In this and other embodiments, the coupler 34 includes a hinge that allows one to pivot the diverter 10 up, out of the water flowing in the canal 12. To pivot the diverter 10 out of the water flowing in the canal, one may insert a hook (not shown) into the eye 36 and pull the diverter 10 out of the water. To allow one to do this while standing on the bank of the canal 12, the hook may be located at the distal end of a pole. By coupling the diverter 10 to the pipe with the coupler 34, one can easily remove the diverter 10 from the stream, river, lake and/or canal to visually inspect the diverter 10 and/or modify the diverter 10 by changing the turbine 26 and/or filter 16 to correspond with changes in the flowing liquid.

Other embodiments of the coupler 34 are possible. For example, the coupler 34 may include a flexible sleeve that allows the diverter 10 to move to the position shown in FIG. 2 while not allowing water from the canal to enter the pipe 14. To keep the diverter 10 from moving downstream from the pressure of the water flowing in the canal 12, the flexible sleeve may include a brace similar to a knee brace that allows one's knee bend in one direction but not another.

FIG. 3 is an exploded, perspective view of the irrigation diverter 10 shown in FIGS. 1 and 2. In this and other embodiments, the diverter 10 includes a housing 40, the filter 16, the cleaner 24, the turbine 26, and the coupler 34.

The housing 40 may be any desired size and shape, and made of any desired material capable of withstanding the loads that it experiences in service. For example, in this and other embodiments the housing includes a cylindrical shape having a 12 inch diameter, and is made of conventional aluminum. The housing also includes a cover 42 that hinders the flow of water through a portion of the turbine 26 to allow the turbine 26 to more freely rotate when the bottom portion of the turbine 26 is exposed to the flow of water. If the cover 42 were absent from the housing 40, then the water flowing through the turbine 26 and above the axis 44 would urge the turbine 26 to rotate in a direction opposite the direction 30 (FIG. 1), and thus, oppose the rotation of the turbine 26 urged by the water flowing through the turbine 26 and below the axis 44.

Other embodiments are possible. For example, the housing may be configured larger or smaller to handle greater or less flows, respectively. Or, the housing may be configured to minimize drag in the water flow, and thus minimize force on the coupler 34 needed to keep the diverter properly oriented in the water flow.

Still referring to FIG. 3, the filter 16 may be any desired filter capable of removing debris from the water flowing through the diverter 10. For example, in this and other embodiments the filter 16 includes a perforated screen made of conventional stainless steel thick enough to resist bending under the pressure of the water contacting it. The filter 16 also includes a hub 46 that is configured to receive an end 48 of the turbine's shaft 50 and hold the end 48, and thus the turbine 26, as the turbine 26 rotates about the axis 44. The perforated screen is sized to extend across the whole cross-section of the housing and may be mounted to the housing with any desired conventional fastening techniques, such as a screw that extends through a hole in the screen and threadingly engages a receptacle (not shown) in the housing 40.

By attaching the filter 16 with one or more conventional bolts, one can change the filter 16 included in the diverter 10 to accommodate changes in the flow of water in the canal 12 (FIGS. 1 and 2). For example, if the water flowing in the canal includes debris that is mostly large in size, such as tree limbs, then one may want to use a filter 16 that has a larger aperture for each hole 22 in the perforated screen to allow much water to be diverted from the canal while preventing debris from flowing through the diverter 10. Or, if the water flowing in the canal includes debris that is mostly small in size, such as silt or small chunks of bark, then one may want to use a filter 16 that has a smaller aperture for each hole 22 in the screen to prevent debris from flowing through the diverter 10. In such a situation, one may have to clean the filter 16 more frequently to maintain a substantially steady flow of water through the diverter 10. To do this one may install a turbine 26 that rotates fast for the given water-flow conditions in the canal, or one may couple the cleaner 24 to the turbine 26 via a transmission (not shown) that increases the speed of the cleaner 24 relative to the speed of the turbine 26.

The cleaner 24 may be any desired cleaner capable of dislodging debris pinned against the filter 16. For example, in this and other embodiments the cleaner 24 includes a plurality of flexible bristles 52 each mounted to a spine 54. The bristles are sized and configured to provide enough stiffness to dislodge debris trapped by the filter 16. The spine 54 may be mounted to the turbine 26 using any desired conventional fastening techniques, such as a bolt that extends through a hole (not shown) in the spine 54 and threadingly engages a receptacle (not shown) in the turbine 26. By attaching the cleaner 16 with one or more conventional bolts, one can change the cleaner 24 included in the diverter 10 to accommodate changes in the debris encounter in flow of water in the canal 12.

Other embodiments are possible. For example, the cleaner 16 may include a solid blade in lieu of the bristles 52 to scrape the filter 16 and dislodge debris trapped by the filter 16. This might be desirable with the debris consists mostly of medium or large sized, solid chunks. In addition, the cleaner 16 may be coupled to the turbine 26 via a transmission. This might be desirable when the flow in the canal is fast and there isn't much debris. In such a situation, the turbine 26 may operate most effectively by rotating fast; but moving the cleaner at the same speed across the filter may simply wear down the cleaner prematurely. This might also be desirable when the flow in a canal is slow and there is much debris in the water. In such a situation, the cleaner may need to be moved across the filter faster than the turbine rotates.

Still referring to FIG. 3, the turbine 26 may be any desired turbine capable of extracting energy from the water flowing in the canal 12 (FIGS. 1 and 2). For example, in this and other embodiments, the turbine 26 includes a waterwheel having a plurality of paddles 56, and is designed to be an undershot turbine—that is, the water flowing through the turbine 26 flows under the axis 44. In addition, the turbine 26 may be configured to operate in any desired flow conditions to provide any desired rotational speed and power. For example, the number of paddles 56 included in the turbine 26 may be more or less than the five shown and may be smaller or larger than the size shown. If the turbine 26 includes more paddles 56, then the difference between the turbine's rotational speed and the speed of the water flowing in the canal 12 will be smaller. If the turbine 26 includes less paddles 56, then the difference between the turbine's rotational speed and the speed of the water flowing in the canal 12 will be greater. Similarly, as the size of each paddle 56 increases, the amount of energy that each paddle 56 extracts from the flow of water increases.

Other embodiments are possible. For example, the turbine 26 may include a Francis turbine, and/or a Pelton turbine.

Still referring to FIG. 3, the coupler 34 may include any desired coupler capable of securely holding the diverter 10 in the flow of water, and allowing the diverter 10 to be easily withdrawn from the flow when desired. For example, in this and other embodiments the coupler 34 includes a hinge that allows movement in the direction indicated by the arrow 58 but prevent movement in the direction indicated by the arrow 60. The hinge is made of conventional aluminum with a stainless steel pin and is mounted to the diverter's outlet 20 using conventional fastening techniques, such as welding.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An irrigation diverter for diverting a flow of liquid from a larger flow of liquid, the irrigation diverter comprising:
a housing having an inlet and an outlet;
a filter disposed between the inlet and the outlet and operable to allow liquid entering the housing through the inlet to flow to the outlet while preventing debris in the liquid from reaching the outlet;
a cleaner operable to scrape the filter to remove the debris from the filter; and
a turbine operable to extract energy from the larger flow of liquid to move the cleaner to scrape the filter.

2. The irrigation diverter of claim 1 wherein the housing includes a cylindrical shape, the outlet is located at an end of the cylindrical shape, and the inlet is located at a side of the cylindrical shape.

3. The irrigation diverter of claim 1 wherein the filter prevents debris that is 0.062 inches and larger from reaching the outlet.

4. The irrigation diverter of claim 1 wherein the filter includes a metal screen.

5. The irrigation diverter of claim 1 wherein the cleaner includes a brush.

6. The irrigation diverter of claim 1 wherein:
the filter includes a disk having a middle and a periphery, and
the cleaner includes a brush that extends from the middle of the disk to the periphery.

7. The irrigation diverter of claim 1 wherein the turbine is a waterwheel.

8. The irrigation diverter of claim 1 wherein the turbine is coupled directly to the cleaner.

9. The irrigation diverter of claim 1 wherein the cleaner continuously scrapes the filter while liquid flows through the filter.

10. The irrigation diverter of claim 1 wherein the housing includes a coupler located at the outlet to allow the housing to be moved out of the larger flow of liquid.

11. An irrigation system comprising:
a canal that carries liquid;
an irrigation diverter disposed in the canal that diverts a flow of liquid from the canal, the irrigation diverter comprising:
a housing having an inlet and an outlet,
a filter disposed between the inlet and the outlet that allows liquid entering the housing through the inlet to flow to the outlet while preventing debris in the liquid from reaching the outlet,
a cleaner that scrapes the filter component to remove the debris from the filter, and
a turbine that extracts energy from the larger flow of liquid to move the cleaner to scrape the filter; and
an irrigation pipe coupled to the outlet of the irrigation diverter's housing that holds and directs liquid flowing through the irrigation diverter's filter to a remote location.

12. The irrigation system of claim 11 wherein the irrigation diverter is submerged in the liquid flowing in the canal while the irrigation diverter diverts liquid toward the remote location.

13. The irrigation system of claim 11 wherein the irrigation diverter is hingedly attached to the irrigation pipe.

14. A method for diverting liquid flowing in a canal, the method comprising:
disposing an irrigation diverter in the liquid flowing in the canal;
directing some of the flowing liquid through an inlet of the irrigation diverter;
preventing debris in the liquid flowing through the inlet from reaching an outlet of the irrigation diverter while allowing the liquid flowing through the inlet to reach the outlet; and
removing the debris from the irrigation diverter while liquid flows through the irrigation diverter's inlet.

15. The method of claim 14 wherein disposing the irrigation diverter in the liquid flowing in the canal includes submerging the irrigation diverter in the flow.

16. The method of claim 14 wherein disposing the irrigation diverter in the liquid flowing in the canal includes pivoting the irrigation diverter about a hinge located at the irrigation diverter's outlet.

17. The method of claim 14 wherein preventing debris in the liquid flowing through the inlet from reaching the outlet includes stopping the debris with a screen.

18. The method or claim 14 wherein removing the debris from the irrigation diverter includes scraping with a brush a screen that stops the debris.

19. The method of claim 14 wherein removing the debris from the irrigation diverter includes continuously scraping with a brush a screen that stops the debris.

20. The method of claim 14 wherein removing the debris from the irrigation diverter while liquid flows through the irrigation diverter's inlet includes rotating a brush across a screen that stops the debris, via a turbine that extracts energy from the liquid flowing in the canal.

21. The method of claim 14 further comprising withdrawing the irrigation diverter from the liquid flowing in the canal by pivoting the diverter about an axis of a coupler.
